(19) United States
(12) Patent Application Publication
(10) Pub. No.: US 2021/0115717 A1
(43) Pub. Date: Apr. 22, 2021

(54) CABLE TENSION DEVICE FOR OVERHEAD DOOR

(71) Applicant: Clopay Corporation, Mason, OH (US)

(72) Inventor: David A. Shives, Cincinnati, OH (US)

(73) Assignee: Clopay Corporation, Mason, OH (US)

(21) Appl. No.: 17/075,927

(22) Filed: Oct. 21, 2020

Related U.S. Application Data
(60) Provisional application No. 62/924,135, filed on Oct. 21, 2019.

(51) Int. Cl. E05D 13/00; E05D 15/16

(52) U.S. Cl. CPC E05D 13/1215; E05Y 2900/106; E05D 15/165

(57) ABSTRACT

An overhead door using a cable tensioning device that is an enclosed drawbar spring that is located in-line with the cable of a counterbalance system, the cable tensioning device maintains the tension on the cable of the counterbalance systems while not interfering with the overhead door hardware, counterbalance system and tracks located to the sides of the overhead door and the cables of the counterbalance system.

This application claims priority under 35 U.S.C. § 119(e) of U.S. Application Ser. No. 62/924,135, filed on Oct. 21, 2019.

### FIELD OF THE INVENTION

The present invention generally relates to a cable tension device and, more particularly, to a cable tension device used with an overhead door.

### SUMMARY OF INVENTION

Overhead doors to cover external and internal openings may comprise panel section that are connected by hinges. These sections further have rollers that are inserted into a track through which the overhead door can be raised into an open position and lowered to a closed position. The track has a vertical section mount to a wall and a horizontal section that is mounted to a ceiling or overhead structure. In addition to the track, a cable system may be attached to a torsion spring bar. The torsion spring bar is engaged with a torsion spring and is connected to cable drums located on each end of the torsion spring bar. The cable system comprises the cable drum being connected to a first end of a cable that then runs between the wall and the vertical portion of the track or, if the cable drum is located to the outside of the vertical track, the cable will be located to the side of the vertical track. The second end of the cable is attached to a bottom bracket, which is mounted to the bottom-most panel on the edge. A roller is often inserted into the bottom bracket. There may be other brackets and hardware also located in what would be the lower left and lower right corner of the overhead door.

One issue with cable systems for overhead doors is that the tension of the cable should be consistent so as not to misalign the cable on the cable drum. As there are two cable drums, it is also an issue if one cable has a different tension from the other cable. The different cable tensions may result in the overhead door not moving in an upward or downward direction in a level fashion, which leads to sections becoming wedged within the track system.

Cable tension devices have been used to maintain consistent tension on the cable. Other approaches include having devices associated with the cable drum to keep the alignment of the cable on the drum.

Springs have been utilized as devices to maintain consistent tension on cables. However, these springs are used when a door does not use a track system next to the opening. The location of the track and the cable provides only a limited area that a cable tension device can be located and there presents the issue of having a difficult attachment points if a spring is attached at the top or bottom of a cable. Also, springs are open structures transition between closed coil structures and extended coil structures that can have items pinched between the spring coils. Cables are located to the sides of the door, and any devices in-line with the cable on the side of doors presents a hazard. Items can become pinched or trapped between the coils causing damage to the spring and the item pinched or trapped between the coils.

Therefore there is a need to provide a tension system utilizing springs located in-line with the cable without disrupting the other necessary hardware on the overhead door.

### DESCRIPTION OF DRAWINGS

FIG. 1 shows a partially exploded view of an overhead door having a cable tension device according to the present application.

FIG. 2 shows an individual door section with open panels.

FIG. 3a shows a drawbar spring.

FIG. 3b shows the individual parts of a drawbar spring unassembled.

FIG. 4 shows a cable tension device comprising a drawbar spring, an enclosure, and a cable connected to the cable tension device.

### DETAILED DESCRIPTION

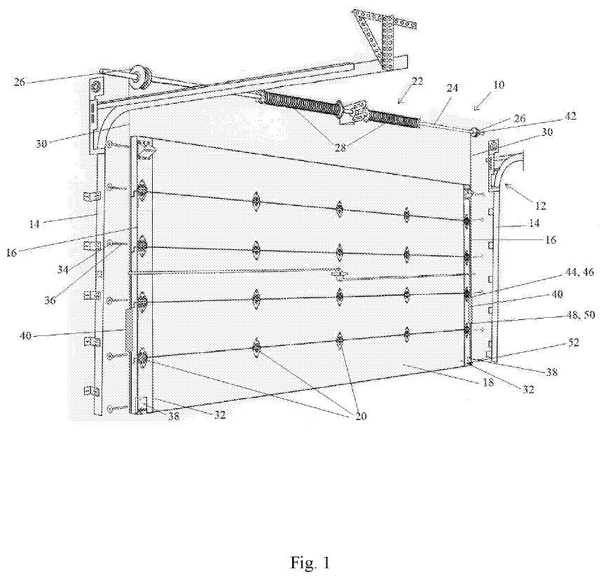

An overhead door with a partially exploded view is shown in FIG. 1 in a downward closed position where the overhead door hardware and door track system are expanded to show the components and location of the counterbalance system. The overhead door (10) is movable between a downward closed position and an upward open position within a door track system (12) which includes a pair of vertical track sections (14) spaced on opposite ends (16) of the overhead door (10) as is known in the art. The overhead door (10) may include at least one section (18), such as a number of individual door sections (18), which extend laterally between the opposed vertical track sections (14). If there is more than one door section (18), the door sections (18) may be hinged together by hinges (20), as known in the art. A counterbalance system (22) is coupled to the overhead door (10) to assist in the movement of the overhead door (10) to and between the downward closed and upward open positions. The counterbalance system (22) comprises a shaft (24) extended between opposite cable drums (26), a torsion spring (28) mounted on the shaft (24), and cables (30) extending from the cable drums (26) to the lower end (32) of the overhead door (10).

Hinges (20) may be mounted on the door sections (18) on the ends of the section (16) and at one or more internal points on the door sections. Each hinge (20) that is located on the ends of the sections (16) includes a roller (34) mounted on a roller shaft (36) generally aligned with a pivot axis of the hinge (20). The roller shaft (36) is mounted to tabs perpendicularly oriented (extending away from door section surface) on the hinge (20) as known in the art. The rollers (34) are captured within the track system (12) to assist in the movement of the overhead door (10) to and between the downwardly closed and upwardly open positions. The overhead door (10) comprises a bottom bracket (38) located at the bottom of the lower end (32) of the overhead door (10).

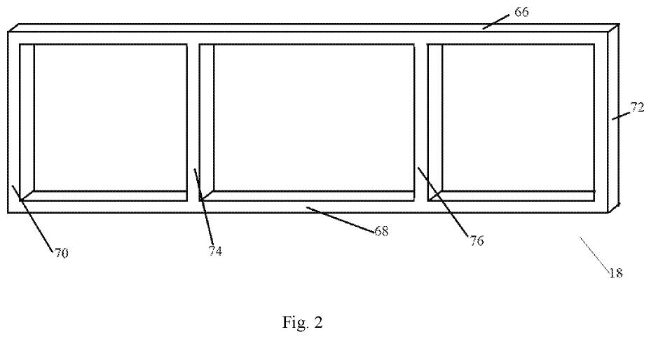

The individual door sections (18) may be constructed of the same materials or different materials. One embodiment of the individual door section (18) is a frame structure, such as made of metal (aluminum, steel, or any other suitable alloy) that does not have a middle panel (open panel) such as that shown in FIG. 2. The metal frame structure comprises at least two vertical stiles (70, 72) and at least two horizontal stiles (66, 68) that are connected to for right angles and a rectangle. The metal frame may further comprise a third vertical stile (74), a fourth vertical stile (76), a fifth vertical stile, and a sixth vertical stile forming multiple middle areas defined by the metal frame structure. The middle areas of this metal frame can be open, the middle areas may comprise a solid metal panel, the middle areas may comprise an open metal structure (e.g., screen, grid, grate, woven metal structure), the middle areas may comprise a polyacrylate panel that is clear or translucent, the middle areas may comprise a polymethylmethacrylate (PMMA) that is clear or translucent, panel the middle areas may comprise a polypropylene panel that is clear or translucent, the middle areas may comprise a glass panel that is clear or translucent, the middle areas may comprise a laminate structure that is intended to have impact resistance such as those discussed in US20040172882 (paragraphs [0045]-[0047]), WO2017136327A1, U.S. Pat. Nos. 7,296,608, 8,733,024, and 4,294,055, all of which are incorporated by reference.

The overhead door (10) may comprise one or more individual sections (18), wherein the individual sections (18) located toward the bottom of the overhead door comprise a laminate structure. The overhead door (10) may comprise at least two sections (18) comprising a metal frame with at least one open middle area. The overhead door (10) may comprise at least two sections (18) comprising a metal frame with at least one middle area comprising a polyacrylate panel, a PMMA panel, or a polypropylene panel, where the panel may be clear or translucent. The overhead door (10) may comprise at least two sections (18) comprising a metal frame with a middle area comprising a laminate structure. The overhead door (10) may comprise at least two sections (18), each section (18) comprising a different middle area material, such as a solid metal panel in a first section (18) and a laminate structure in a second section (18).

The counterbalance system (22) comprises a shaft (24) extended between opposite cable drums (26), a torsion spring (28) mounted on the shaft (24), and cables (30) extending from the cable drums (26) to the lower end of the door (32), the lower end of the door (32) may comprise a bottom bracket (38). The cable (30) of the present application comprises a cable tension device (40). The cable (30) comprising a first attachment point (42) is located at the cable drum (26), a second attachment point (44) located at a first end (46) of the cable tension device (40), a third attachment point (48) located at a second end (50) of the cable tension device (40), and a fourth attachment point (52) located at the bottom bracket (38). The cable tension device (40) comprising at least one drawbar spring (54) having a first end (56) and a second end (58). The cable tension device (40) further comprising an enclosure (60), the enclosure comprising a first end (62), and a second end (64). The enclosure (60) is of a sufficient length to accommodate at least one or more drawbar springs (54) in a resting state and in its extended state.

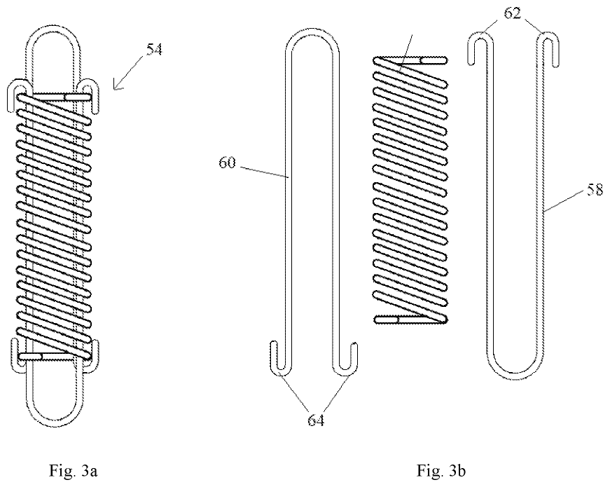

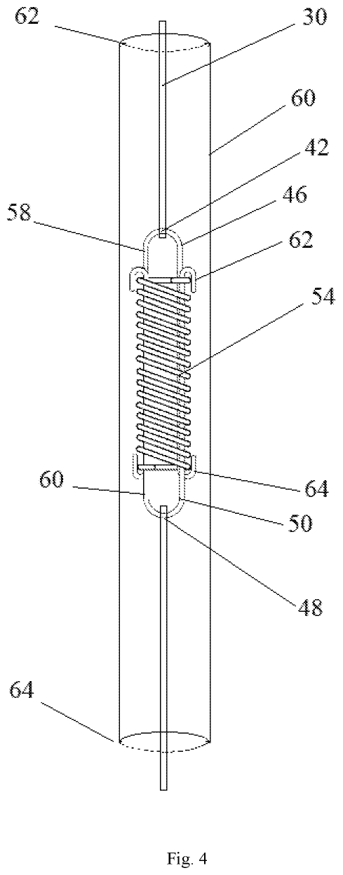

A drawbar spring (54) shown in FIG. 3a as individual components comprises an extension spring (56) and two loops (58, 60) that are located in opposite orientations to each other within the center of the extension spring (56), each loop having a pair of hooks (62, 64) that encircles the inactive coil of the extension spring (56) as shown in FIG. 3b. If a force decreases on the cable (30) (loss of tension), then the drawbar spring (54) will apply a force to pull the second attachment point (44) of the cable towards the third attachment point (48) of the cable to maintain the tension on the cable (30). The outside diameter, inside diameter, wire diameter (gauge), free length and extended length of the drawbar spring (54) are selected to correspond to the appropriate forces on the cable (30) in connection with the counterbalance system (22) and overhead door (10) mass. The outside diameter should be selected to correspond to the area within the counterbalance system (22), the overhead door (10) and the vertical track sections (14) that is available for the cable tension device (40). Suitable outside diameters are from 0.25 inches to 2 inches, such as 0.5, 0.75, 1, 1.25, 1.5, 1.75, and 2 inches. The inner diameter is selected to accommodate the loops (58, 60) within the center of the extension spring (56). The wire diameter of the spring (56) is selected to achieve the desired spring rate needed to maintain tension on the cable (30) for the overhead door (10) selected. Suitable wire diameter would be 0.1 to 0.3 inches. A compression spring constant (k) may be calculated by Equation 1.

k=Gd⁴/(8nD³) Equation 1:

k is the spring constant (pound of load per inch of deflection); G is the modulus of rigidity of the selected spring material (pounds per square inch); d is the wire diameter (inches); n is the number of active coils (will be less than the total number of coils); D is the mean coil diameter (outer diameter of spring less wire diameter in inches), and G is calculated from Equation 2:

G=E/(2(1+v)) Equation 2:

Where E is the elastic modulus of the selected material of the spring and v (nu) is the Poisson Ratio.

Drawbar spring rates may also be calculated according to Hooke's Law shown in Equation 3:

k=(P2−P1)/(L1−L2) Equation 3:

Where P1 is the load at about 20% deflection and L1 is the spring length at about 20% deflection; P2 is the load at about 80% deflection, and L2 is the spring length at about 80% deflection. The free length of the drawbar spring can be from 1 to 12 inches, and the extended length of the drawbar spring should be less than the enclosure length.

A series of two or more drawbar springs can be used for the cable tension device (40). The first drawbar spring is connected to the second drawbar spring. If there are more than two drawbar springs, then the series is connected at opposing ends of the respective drawbar springs. The enclosure (68) has a first end (62) and a second end (64). The enclosure (68) should be selected to correspond to the area available between the wall defining the opening that the overhead door closes, the counterbalance system (22), the overhead door (10) and the vertical track sections (14) for the cable tension device (40) while being large enough to contain the drawbar spring (54) at its extended length. The enclosure (68) should be such that the drawbar spring (54) can be connected and interact with the second connection point (44) and the third connection point (48) of the cable (30). The enclosure (68) may be a solid material or an open structured material such as a wire screen or mesh. The enclosure (68) is connected to the drawbar spring (54) or the cable (30) in such a way as to allow for the free movement of the drawbar spring (54).

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. The words “right”, “left”, “lower” and “upper” designate directions in the drawings to which reference is made. The words “inwardly” and “outwardly” refer to directions toward and away from, respectively, the geometric center of the closure locking system. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as a limitation on the claims. Any claims directed to the methods of the present invention should not be limited to the performance of their steps in the order written, and one skilled in the art can readily appreciate that the steps may be varied and still remain within the spirit and scope of the present invention.

1. An overhead door comprising a cable tension device; the cable tension device comprising at least one drawbar spring having a first end and a second end; an enclosure with an enclosure first end and an enclosure second end; a cable comprising a first attachment point, a second attachment point, a third attachment point and a fourth attachment point; wherein the drawbar spring is housed in the enclosure, the first end of the at least one drawbar spring connected to the second attachment point of the cable and the second end of the at least one drawbar spring connected to connected to the third attachment point of the cable.

2. The overhead door of claim 1, wherein the first attachment point of the cable connected to a cable drum; the cable drum located above the overhead door.

3. The overhead door of claim 1, wherein the fourth attachment point of the cable connected to a bottom bracket; the bottom bracket attached to the overhead door.

4. The overhead door of claim 1, wherein the overhead door further comprises at least one door section, the section comprising a first bottom bracket and a first roller located on the left side of the section, and a second bottom bracket and a second roller located at the right side of the section; wherein the fourth attachment point of the cable is connected to the first bottom bracket.

5. The overhead door of claim 4, wherein the at least one section of the overhead door comprises an open metal frame, a non-metal material, a flexible material, a laminate material.

6. The overhead door of claim 1, wherein the overhead door further comprises a second cable, the second cable comprising a first attachment point, a second attachment point, a third attachment point and a fourth attachment point; a second cable tension device the second cable tension device comprising at least one drawbar spring having a first end and a second end; an enclosure with an enclosure first end and an enclosure second end.

7. The overhead door of claim 1, wherein the drawbar spring is housed in the enclosure, the first end of the at least one drawbar spring connected to the enclosure first end; the enclosure first end connected to the second attachment point of the cable and the enclosure second end connected to the third attachment point of the cable.

8. The overhead door of claim 1, wherein the overhead door further comprises a second cable, the second cable comprising a first attachment point, a second attachment point, a third attachment point and a fourth attachment point; a second cable tension device the second cable tension device comprising at least one drawbar spring having a first end and a second end; an enclosure with an enclosure first end and an enclosure second end.

9. The overhead door of claim 8, wherein the at least one drawbar spring is housed in the second enclosure, the first end of the at least one drawbar spring connected to the second enclosure first end; the first end of the at least one drawbar spring connected to the second attachment point of the second cable and the second end of the at least one drawbar spring connected to the third attachment point of the second cable.

10. A cable tension device comprising at least one drawbar spring having a first end and a second end; an enclosure with an enclosure first end and an enclosure second end; a cable comprising a first attachment point, a second attachment point, a third attachment point and a fourth attachment point; wherein the drawbar spring is housed in the enclosure, the first end of the at least one drawbar spring connected to the second attachment point of the cable and the second end of the at least one drawbar spring connected to connected to the third attachment point of the cable.
